(19) United States
(12) Patent Application Publication
(10) Pub. No.: US 2026/0315325 A1
(43) Pub. Date: Oct. 15, 2026

(54) Fluid Transfer System With Selector Mechanism

(71) Applicant: Becton, Dickinson and Company, Franklin Lakes, NJ (US)

(72) Inventor: Zhee Min Jimmy Yong, Singapore (SG)

(21) Appl. No.: 19/177,795

(22) Filed: Apr. 14, 2025

(51) Int. Cl. A61J 1/20

(52) U.S. Cl. CPC A61J 1/2051; A61J 1/201

(57) ABSTRACT

A connector for fluid transfer is disclosed. The connector includes a first end, a second end opposite the first end, and a longitudinal axis extending from the first end to the second end. A piercing member is provided proximate the first end, the piercing member including at least one opening therein. A lumen extends from the at least one opening of the piercing member to the membrane, and at least one engagement member is positioned between the first end and the second end, the at least one engagement member being movable in a direction transverse to the longitudinal axis. The connector also includes a selector mechanism movable with respect to the at least one engagement member and configured to at least partially restrict movement of the at least one

### BACKGROUND OF THE INVENTION

### 1. Field of the Invention

The present disclosure relates generally to devices and methods of use thereof for the closed transfer of fluids. More particularly, the present disclosure relates to releasably engageable components for secure fluid transfer.

### 2. Description of Related Art

Reconstituting, transporting, and administering hazardous drugs, such as cancer treatments, can put health care providers at risk of exposure to these medications and present a major hazard in the health care environment. For example, nurses treating cancer patients risk being exposed to chemotherapy drugs and their toxic effects when administering these potentially harmful drugs due to insecure connections or inadvertent disconnection of the delivery devices or adapters used to transport or administer such drugs. Unintentional chemotherapy exposure can affect the nervous system, impair the reproductive system, and bring an increased risk of developing blood cancers in the future. In order to reduce the risk of health care providers being exposed to toxic drugs, the secure, closed transfer of these drugs is important.

Accordingly, the present disclosure provides connectors, assemblies, and components thereof that reduce the likelihood of an unintentional disconnection of a fluid connection.

### SUMMARY OF THE INVENTION

In accordance with one aspect, the present disclosure is directed to a connector, having a first end, a second end opposite the first end, and a longitudinal axis extending from the first end to the second end, a piercing member proximate the first end, the piercing member including at least one opening therein. The connector also includes a lumen extending from the at least one opening of the piercing member to the membrane, at least one engagement member positioned between the first end and the second end, the at least one engagement member being movable in a direction transverse to the longitudinal axis, and a selector mechanism movable with respect to the at least one engagement member and configured to at least partially restrict movement of the at least one engagement member.

In certain configurations, the selector mechanism includes a selector body rotatable with respect to the piercing member. The selector mechanism may include a selector body that defines a passage therethrough, and wherein at least a portion of the piercing member extends through the passage. The passage and the piercing member may be coaxial.

In certain configurations, the connector further includes a flange longitudinally positioned between the piercing member and the second end, the flange having a width greater than a width of the piercing member. The flange may define a channel extending at least partially therethrough. The selector mechanism may include a selector body extending through at least a portion of the flange. The selector body may define one or more apertures positionable laterally adjacent to the at least one engagement member.

In certain configurations, the connector further includes a plurality of axially-offset steps extending around at least a portion of the channel, and the selector body includes one or more protrusions abutting and movable with respect to the plurality of steps. The connector may include a membrane proximate the second end. Optionally, the at least one the engagement member includes a depressible surface including a ramp angled with respect to the longitudinal axis. In other configurations, the at least one the engagement member is pivotable about a cantilever joint.

In accordance with another embodiment of the present invention, a system for transferring fluids includes a connector, having a first end, a second end opposite the first end, and a longitudinal axis extending from the first end to the second end, a piercing member proximate the first end, the piercing member including at least one opening therein. The connector further includes a lumen extending from the at least one opening of the piercing member to the membrane, a plurality of engagement members radially spaced about the connector and positioned between the first end and the second end, with each of the plurality of engagement members being movable in a direction transverse to the longitudinal axis, and a selector mechanism rotatably coupled to the connector. The selector mechanism may include a selector body defining a sidewall with a plurality of apertures therein, wherein the selector body is rotatable from (i) a first position in which each of the apertures is radially aligned with one of the plurality of engagement members to permit movement of the plurality of engagement members, to (ii) a second position wherein each of the apertures is radially offset with one of the plurality of engagement members such that the sidewall at least partially obstructs movement of the plurality of engagement members.

In certain configurations, the selector mechanism is coaxially mounted on the connector. The selector body may include a knob defining a passage therethrough, and wherein at least a portion of the piercing member extends through the passage. The connector may further include a flange longitudinally positioned between the piercing member and the second end, the flange having a width greater than a width of the piercing member, and wherein the selector body extends at least partially through the flange.

In certain configurations, the flange defines a channel extending at least partially therethrough, and a plurality of axially-offset steps at least partially extending around a perimeter of the channel, and wherein the selector body includes one or more protrusions engaging the plurality of steps. The selector body may include one or more retention tabs configured to restrict axial movement between the connector and the selector body.

In other configurations, the system may also include an adapter releasably engageable with the connector. The adapter including a housing defining a first end, a second end, and a longitudinal axis extending from the fist end to the second end, a cannula positioned within the housing, and a seal arrangement movably positioned within the housing. The second end of the connector is positionable within the housing such that the cannula is placed in fluid communication with the lumen.

Optionally, the plurality of engagement members of the connector are configured to engage the housing of the adapter to resist axial movement between the connector and the adapter.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a perspective view of an example of a fluid transfer system constructed in accordance with the principles of the present invention.

FIG. 2 is a perspective view of an example of a connector for a fluid transfer system constructed in accordance with the principles of the present invention.

FIG. 3 is another perspective view of the connector of FIG. 2.

FIG. 4 is a partial side view of the connector of FIG. 2.

FIG. 5 is a perspective view of an example of an adapter for a fluid transfer system constructed in accordance with the principles of the present invention.

FIG. 6 is a side cross-sectional view of the adapter of FIG. 5.

FIG. 7 is a perspective view of an example of a selector mechanism for a fluid transfer system constructed in accordance with the principles of the present invention.

FIG. 8 is an additional perspective view of the selector mechanism of FIG. 7.

FIG. 9 is a perspective view of another example of a selector mechanism for a fluid transfer system constructed in accordance with the principles of the present invention.

FIG. 10 is a side perspective view of an example of a selector mechanism and connector assembly for a fluid transfer system constructed in accordance with the principles of the present invention.

FIG. 11 is a side perspective view of an alternative configuration of the selector mechanism and connector assembly of FIG. 10.

FIG. 12 is a side cross-sectional view of an assembled an example of a fluid transfer system constructed in accordance with the principles of the present invention.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the concept as it is oriented in the drawing figures. However, it is to be understood that the concept may assume various alternative variations, except where expressly specified to the contrary. It is also to be understood that the specific devices illustrated in the attached drawings, and described in the following specification, are simply exemplary embodiments of the concept. Hence, specific dimensions and other physical characteristics related to the embodiments disclosed herein are not to be considered as limiting.

The word “comprising” and “comprises”, and the like, does not exclude the presence of elements or steps other than those listed in any claim or the specification as a whole. In the present specification, “comprises” means “includes” and “comprising” means “including.”

As used herein, “at least one of” is synonymous with “one or more of.” For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “at least” is synonymous with “greater than or equal to.” The terms “first”, “second”, and the like are not intended to refer to any particular order or chronology, but refer to different conditions, properties, or elements. As used herein, the singular form of “a”, “an”, and “the” include plural referents unless the context clearly dictates otherwise.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The present disclosure provides systems and methods of use thereof for the secure, closed transfer of potentially hazardous compounds minimizing the likelihood of an inadvertent or unintentional disconnection. Referring now to the figures in which like reference designations refer to like elements, examples of a fluid transfer system 10 generally including a connector 12, an adapter 14, and a selector mechanism 16 is shown.

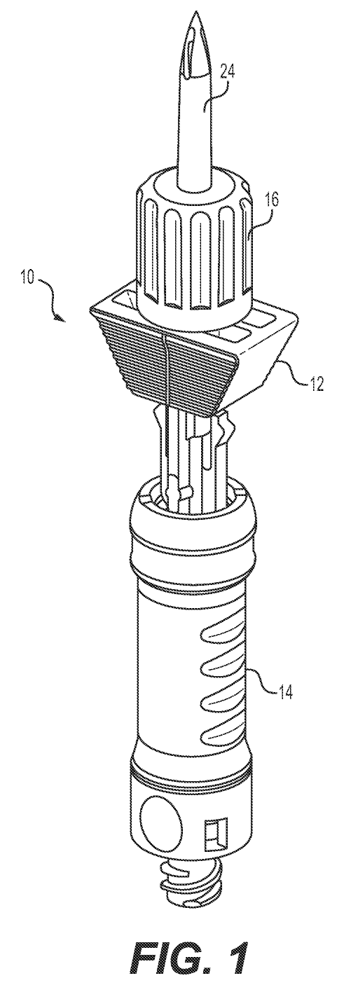

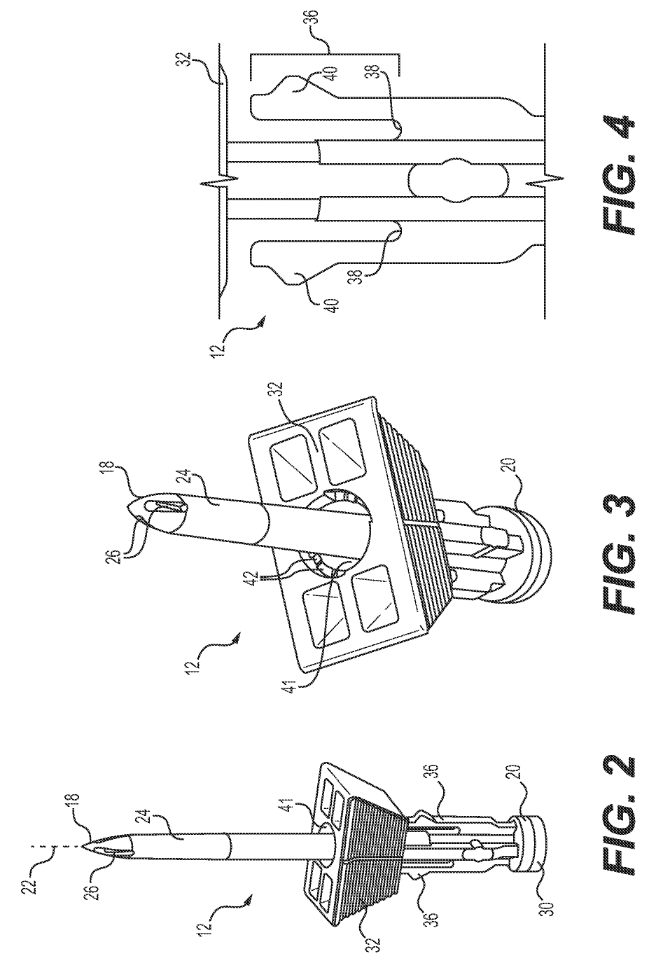

Referring to FIGS. 1-4, an example of the connector 12 is shown and generally includes or defines a first end 18, a second end 20 opposite the first end 18, and a longitudinal axis 22 extending along the length of the connector 12 between the first and second ends. The connector 12 includes or defines a piercing member 24 substantially parallel to the longitudinal axis 22 and extending towards or otherwise defining the first end 18 of the connector 12. The piercing member 24 includes an angled, pointed, or sharp surface configured to pierce a membrane, seal, or other barrier of a fluid container or other component of a fluid delivery or storage system. The piercing member 24 includes one or more openings 26 in fluid communication with a lumen 28 extending along an interior of the connector 12 from the first end 18 to the second end 20. The openings 26 may be defined or included in a sidewall or surface of the piercing member 24 to avoid blockage or coring when the piercing member 24 is inserted through a membrane or barrier.

The connector 12 may include a membrane 30 at or adjacent to the second end 20 of the connector 12. The membrane 30 seals the lumen 28 at or near the second end 20 of the connector 12 until pierced for secure transfer of fluids as described further herein. The membrane 30 may include one or segments of fluid impermeable material, layers, coatings or otherwise to prevent or substantially reduce fluid flow through the lumen at the second end 20.

The connector 12 may include or define a flange 32 extending radially substantially perpendicular or transvers to the longitudinal axis 22. The flange 32 may be positioned at or adjacent to a base 34 of the piercing member 24 opposite the first end 14 where the angled, pointed, or sharp surface of the piercing member 24 resides. The flange 32 may define a dimeter and/or width greater than a diameter or width of the piercing member 24 such that the flange 32 provides a greppable surface configured to facilitate pushing the piercing member 24 into a container, fluid line, or other conduit.

The connector 12 includes a locking mechanism operable and configured to releasably engage or couple the connector 12 to the adapter 14. The locking mechanism includes one or more engagement members 36 positioned on or extending from a portion of the connector 12. The engagement members 36 may couple to or extend from a portion of the connector 12 at a base or joint 38 located between the flange 32 and the second end 20 in the direction of the longitudinal axis 22. The base or joint 38 may include a cutout, curvature, living hinge, or other structure enabling at least a portion of the engagement members 36 to move laterally or radially in a direction substantially transverse or perpendicular to the longitudinal axis 22. As shown in FIG. 4, for example, a slot is defined between the engagement members 36 and the main, central body of the connector 12, which allows for lateral or radial movement of the engagement members 36. A length and width of the slot between the engagement members 36 and the connector 12 can be varied to change the force and amount of deflection of the engagement members 36. The one or more engagement members 36 may be biased to retain or return to a particular radial or lateral position upon the application and removal of force. For example, the one or more engagement members 36 may include or constitute a cantilever arm that is depressible and movable inwardly in a radial or lateral direction, but returns to an initial outward position when the inward force is removed.

The one or more engagement members 36 may each define a ramp or angled surface 40 protruding therefrom. The ramp 40 may be longitudinally positioned between the shelf 38 and the base or joint 34. The ramp 40 may be angled with respect to the longitudinal axis 22 and be operable or configured to move the one or more engagement members 36 inward radially or laterally when a force is exerted thereon. The ramp 40 may increase in width in a direction extending from the second end to the first end. The ramp 40 may form a camming arrangement such that an axial force applied to the engagement members 36 results in lateral or radial movement of the engagement members 36.

The connector 12 may include a plurality of engagement members 36 radially spaced or positioned about the connector. In the illustrated example, there are two engagement members positioned radially opposite each other (e.g., 180 degrees apart) around the circumference or perimeter of the connector 12. The quantity and placement of the engagement members may be modified to suit a particular application or use.

The size, shape, and configuration of the various features of the engagement members 36 may be modified to provide a desired degree of movement, displacement, or force exertion during assembly, disassembly, and/or use of the components and features described herein. The connector 12 may be constructed or molded as a unitary component, or alternatively may be assemble from distinct parts to provide the features described herein. The connector 12 may be constructed from one or more sterilizable and/or biocompatible polymers, metals, and/or alloys or mixtures thereof.

The connector 12 may include or define a channel 41 extending at least partially through the flange 32. The channel 41 may extend in a direction substantially parallel to the longitudinal axis 22, and may circumscribe and/or extend around an exterior of at least a portion of the piercing member 24. A plurality of steps 42 may extend around a perimeter or edge of at least a portion of the channel 41. Each of the plurality of steps 42 may be radially and axially offset from the remaining plurality of steps.

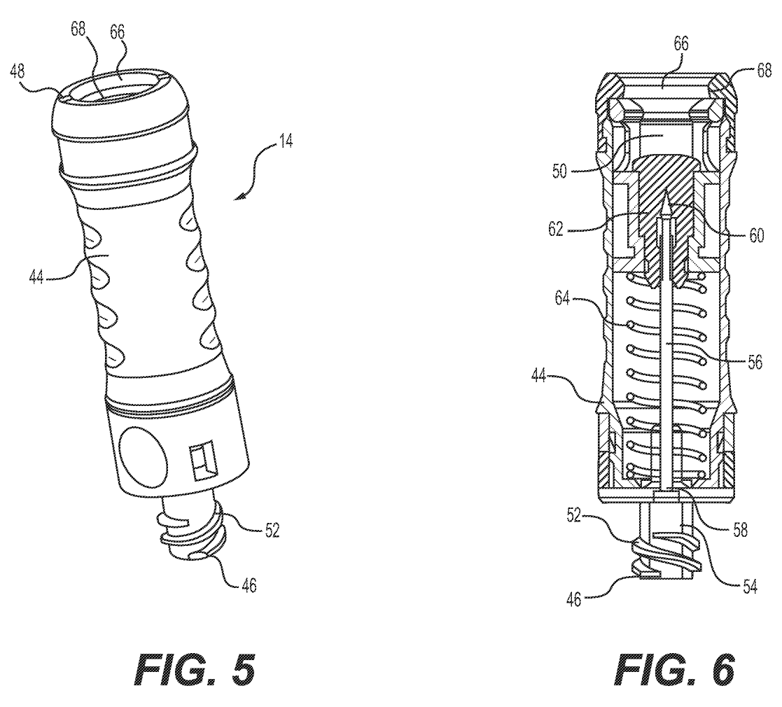

Now referring to FIGS. 1 and 5-6, an example of the adapter 14 is illustrated. The adapter 14 is configured to receive at least a portion of the connector 12 therein, and is further configured to connect to a syringe (not shown) or other medical device or fluid container. The medical device can be, for example, a patient line, vial adapter, fluid container, or infusion adapter. In other examples, the container can be a medical vial, syringe barrel, IV bag, or similar container for holding a fluid to be administered to a patient. The adapter 14 can be used to facilitate the closed transfer of fluids between the syringe, through the connector 12, and into a medical device or fluid container. The adapter 14 is similar to and operates in a similar manner as the syringe adapter shown and described in United States Patent No. 10,744,315, which is hereby incorporated by reference in its entirety.

The adapter 14 includes a housing 44 having a first end 46, a second end 48, and an interior cavity 50. The first end 46 of the housing 44 of the adapter 14 may include a syringe or device attachment feature 52, such as a female luer connector, that defines a passageway 54. Although a female luer connector is shown for connection with a corresponding male luer connector of a syringe (not shown), other suitable connection arrangements may be utilized for connection to a syringe, container, or any other medical device. A cannula 56 is secured to the housing 44 and defines a proximal end 58 adjacent to or otherwise in fluid communication with the passageway 54, and the cannula 56 defines or includes a distal end 60 within the cavity 50 of the housing 44 extending in the direction of the second end 48.

The adapter 14 further includes a seal arrangement 62 positioned within the housing 44 and configured to move within the interior cavity 50 in an axial direction along the longitudinal axis 22. The seal arrangement 62 may include one or more collets or other structural framing components and/or one or more membranes, barriers, or other fluid impermeable features to prevent or substantially reduce fluid flow through the distal end 60 of the cannula 56 until the adapter 14 is coupled to the connector 12 and is otherwise prepared for fluid transport.

The adapter 14 may include a drive member 64 that biases the axially-movable seal arrangement 62 towards a first position adjacent to or in proximity to the second end 48 of the housing 44. The drive member 64 may include a spring or other biasing means configured to provide the features described herein. Upon an application of an axial force, the biasing of the drive member 64 is overcome, and the seal arrangement 62 can be moved axially in a direction towards the first end 46 of the housing 44, such that the distal end 60 of the cannula 56 pierces or otherwise passes through the seal arrangement 62, as described further herein.

The adapter 14 defines or includes an opening 66 at the second end 48 that is sized and shaped to receive at least a portion of the connector 12 therethrough. In particular, the second end 20 of the connector 12 is positionable through the opening 66 in the second end 48 of the housing 44 such that at least a portion of the connector 12 is positioned within the interior cavity 50 of the housing 44. The connector 12 may be positioned within the housing 44 such that the membrane 30 of the connector 12 abuts or is otherwise adjacent to the seal arrangement 62 of the adapter 14.

The adapter 14 may include or define one or more retention elements 68 adjacent to or in proximity to the opening 66 at the second end 48 of the housing 44. The one or more retention elements 68 may be operable or otherwise configured to engage the locking mechanism of the connector 12 for attachment and detachment of the connector to the adapter 14. The one or more retention elements 68 may include, for example, a protruding rim circumscribing the opening 66 of the housing 44 and having a smaller diameter than the opening 66 that is engageable within the ramp 40 of the engagement members 36 of the connector. In another example, the one or more retention elements 68 may include, for example, one or more discrete protrusions extending inwardly around the opening 66 that are engageable within the ramp 40 of the engagement members 36 of the connector 12.

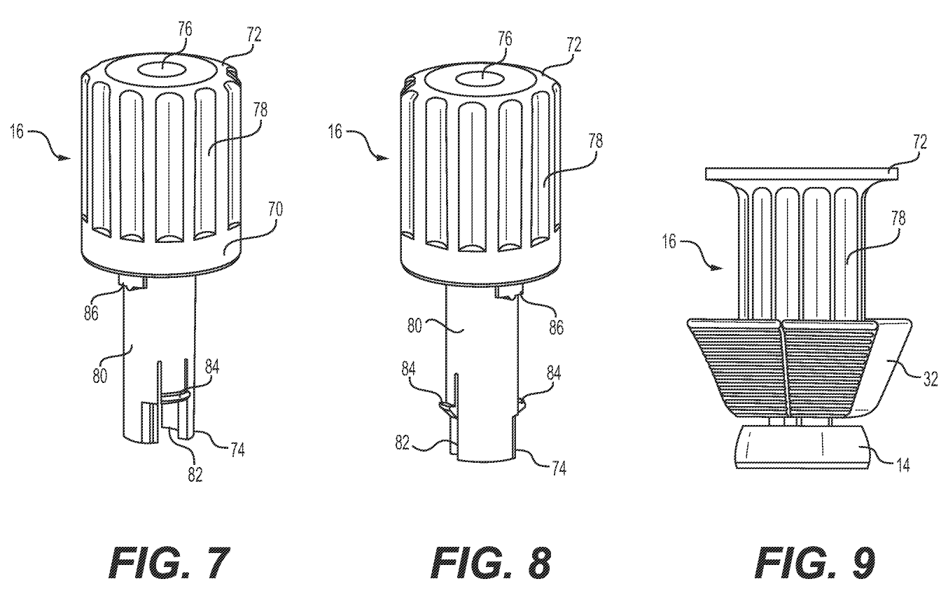

The selector mechanism 16 may be configured and/or operable to selectively permit or prevent disengagement between the connector 12 and the adapter 14. In one example, the selector mechanism 16 may be selectively positionable on or about the connector 12 to affect a range of movement of the engagement members 36 with respect to the connector 12 and/or adapter 14 to facilitate or prevent disengagement. Now referring to FIGS. 1 and 7-11, the selector mechanism 16 may generally include or define a selector body 70 coupled to the connector 12. The selector body 70 may include or define a first end 72 and a second end 74. The selector body 70 may include or define a passage 76 therein or therethrough configured to receive at least a portion of the connector 12 therein. For example, the passage 76 may be sized and/or shaped to receive at least a portion of the piercing member 24 therethrough.

The first end 72 of the selector body 70 may include or define a knob 78 or other gripping structure to facilitate manipulation of the position of the selector body 70 with respect to the connector 12 as described herein. In one example, as shown in FIG. 9, the first end 72 may include or refine an outwardly flared surface or rim to provide an axial pressing surface to aid in manipulating and/or inserting the system 10 and/or connector, as described herein.

The selector body 70 may include or define a sidewall 80 extending along a length thereof to the second end 74. The sidewall 80 may have a substantially cylindrical orientation and include or define at least a portion of the passage 76 therein. The sidewall 80 may include or define one or more apertures 82 that are positionable laterally adjacent and/or in proximity to at least a portion of the engagement members 36 of the connector 12. The one or more apertures 82 may be radially spaced or positioned about the selector body 70. In the illustrated example, there are two apertures 82 positioned radially opposite each other (e.g., 180 degrees apart) around the circumference or perimeter of the selector body 70. The quantity and placement of the apertures 82 may be modified to suit a particular application or use.

The selector body 70 may include or define one or more retention tabs 84 configured to engage at least a portion of the connector 12 to reduce or limit a range of axial movement between the selector body 70 and the connector 12. In one example, the one or more retention tabs may extend from and/or be partially defined by the sidewall 80 at or near the second end 74 of the selector body 70. In one aspect or example, each of the one or more retention tabs 84 may include or define a living hinge or other cantilevering joint to enable the retention tabs 84 to be depressed inward. Each of the one or more retention tabs 84 may be radially aligned with and/or terminate just above one of the one or more apertures 82. The one or more retention tabs 84 may be radially spaced or positioned about the selector body 70. In the illustrated example, there are two retention tabs 84 positioned radially opposite each other (e.g., 180 degrees apart) around the circumference or perimeter of the selector body 70. The quantity and placement of the retention tabs 84 may be modified to suit a particular application or use.

The selector body 70 may include or define one or more protrusions 86 configured to provide tactile feedback and/or adjustment of axial positioning between the selector body 70 and the connector 12. For example, the one or more protrusions 86 may extend outward from the sidewall 80 at an axial position configured to engage the one or more steps 42 of the connector 12, as described herein. The one or more protrusions 86 may be radially spaced or positioned about the selector body 70. In the illustrated example, there are two retention tabs 84 positioned radially opposite each other (e.g., 180 degrees apart) around the circumference or perimeter of the sidewall 80 of the selector body 70. The quantity and placement of the protrusions 86 may be modified to suit a particular application or use.

The selector body 70 may be coupled to the connector 12 such that the selector body is rotatably moveable with respect to the connector 12. The selector body 70 may be coaxially coupled to the connector 12 such that the piercing member 42 passes through the passage 76 and extends outward and above the first end 72 of the selector body 70. The knob 78 or other portion of the selector body 70 may abut or otherwise be positioned in proximity to a top or upper surface of the flange 32. The second end 74 of the selector body 70 may pass through and extend below or out of the channel 41 of the connector 12 such that at least a portion of the sidewall 80 and the one or more apertures 82 are coplanar with and/or lateral to the ramp 40 of the engagement members 36 of the connector 12. The one or more axial retention tabs 84 may be positioned adjacent to or abutting an underside or bottom of the flange 32. The one or more protrusions 86 may be positioned adjacent to, abutting, or otherwise in contact with the one or more steps 42 of the connector.

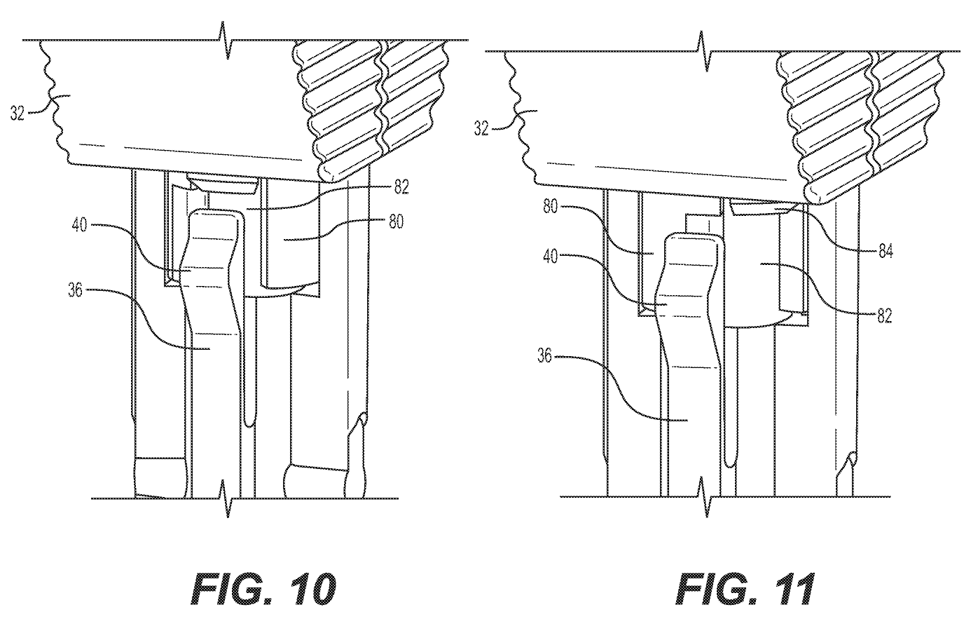

The selector body 70 may be rotatably adjustable with respect to the connector 12 to attain a first position where the one or more apertures 82 are aligned with the ramp 40 or other portion of the engagement members 36, as shown in FIG. 10, to permit unrestricted movement and/or deflection of the engagement member 36. In this first position, the engagement members 36 of the connector 12 can engage and disengage the adapter 14.

The selector body 70 may be rotatably adjustable with respect to the connector 12 to attain a second position where the one or more apertures 82 are offset with the ramp 40 or other portion of the engagement members 36, and a portion of the sidewall 80 of the selector body is aligned with the ramp 40 or other portion of the engagement members 36, as shown in FIG. 11. The second position of the selector body at least partially restricts, obstructs, or limits movement and/or deflection (or a range thereof) of the engagement member 36 in an inward, lateral direction or otherwise towards a centerline of the connector 12. With the selector body 70 in this second position, the engagement members 36 of the connector 12 cannot sufficiently deflect to engage or disengage the adapter 14.

Movement of the selector body 70 from the first position to the second position (and vice versa) may be indicated to a user through tactile feedback occurring from the one or more protrusions 86 traversing the one or more steps 42 of the connector, which may also provide an axial shift between the selector body 70 and the connector 12 that restricts any further radial or axial movement between the selector body 70 and the connector 12, limited at least in part by the retention tabs 84.

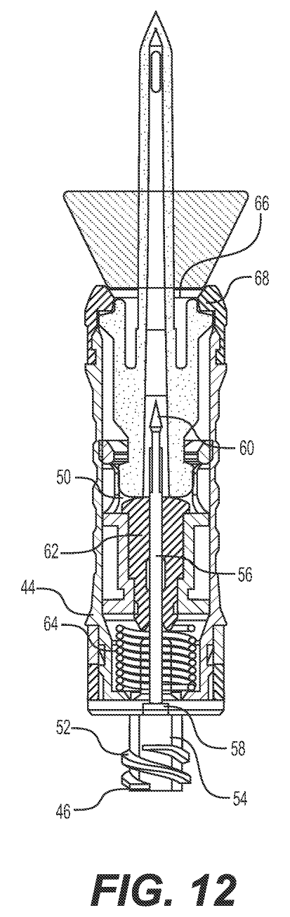

In an exemplary method of assembly and use, as shown in FIG. 12, the connector 12 is engaged with the adapter 14 to provide a secure fluid flow path therethrough for the delivery of drugs or other medicaments. The selector mechanism 16 may be in the first position, and the second end 20 of the connector 12 may be passed through the opening 66 of the second end 48 of the adapter 14. As a portion of the connector 12 axially passes through the opening 66, the one or more retention elements 68 may come into contact with at least a portion of the one or more engagement members 36 of the connector 12 such that the one or more engagement members 36 are moved inward in a radial or lateral direction. The inward deflection of the engagement members 36 may result from the retention elements 68 or other portion of the housing 44 contacting and exerting a radial/lateral force on the ramp 40 of the engagement members 36. Continued axial movement of the connector 12 into the cavity 50 of the housing 44 continues the contact and deflection of the ramp 40, and thus the engagement members 36, inwardly until the one or more engagement members 36 passes through the opening 66 and is adjacent to the one or more retention elements 68. Once the connector 12 has been sufficiently inserted into cavity 50 of the adapter 14, the engagement members move outward radially or laterally to their initial position due to the biasing of a cantilever or other constitution of the engagement members.

The selector mechanism 16 may be transitioned to the second position to prevent disengagement of the connector 12 from the adapter 14. Requiring a radial adjustment of the selector mechanism 70 to transition from the first position to the seconds position reduces the likelihood that the connector 12 will be inadvertently disconnected from the adapter 14 solely by an axial force, which could typically be exerted during insertion, positioning, and/or or removal of the piercing member from an IV system or container.

The coaxial insertion and positioning of the connector 12 within the cavity 50 of the housing 44 axially moves the seal arrangement 62 towards the first end 46 of the adapter 14. Movement of the seal arrangement 62 causes the distal end 60 of the cannula 56 to pierce the seal arrangement 62 and the membrane 30 of the connector 12, resulting in the cannula 56 being at least partially positioned within the lumen 28 of the connector. As a result, the assembled adapter 14 and connector 12 provides a fluid flow path through the passageway 54 in the first end 46 of the adapter 14, through the cannula 56, into the lumen 28 extending through the piercing member 24 of the connector, and out of the openings 26 at the first end 14 of the connector 12. As previously described, the piercing member 24 may be inserted into a container, IV line or bag, or other component of a fluid transfer system for secure transfer of fluids.

It will be appreciated by persons skilled in the art that the present disclosure is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the disclosure. A variety of modifications and variations are possible in light of the above teachings without departing from the scope and spirit of the disclosure, which is limited only by the following claims.

What is claimed is:

1. A connector, comprising:
a first end, a second end opposite the first end, and a longitudinal axis extending from the first end to the second end;
a piercing member proximate the first end, the piercing member including at least one opening therein;
a lumen extending from the at least one opening of the piercing member to the membrane;
at least one engagement member positioned between the first end and the second end, the at least one engagement member being movable in a direction transverse to the longitudinal axis; and
a selector mechanism movable with respect to the at least one engagement member and configured to at least partially restrict movement of the at least one engagement member.

2. The connector of claim 1, wherein the selector mechanism includes a selector body rotatable with respect to the piercing member.

3. The connector of claim 1, wherein the selector mechanism includes a selector body that defines a passage therethrough, and wherein at least a portion of the piercing member extends through the passage.

4. The connector of claim 3, wherein the passage and the piercing member are coaxial.

5. The connector of claim 1, further comprising a flange longitudinally positioned between the piercing member and the second end, the flange having a width greater than a width of the piercing member.

6. The connector of claim 5, wherein the flange defines a channel extending at least partially therethrough.

7. The connector of claim 6, wherein the selector mechanism includes a selector body extending through at least a portion of the flange.

8. The connector of claim 7, wherein the selector body defines one or more apertures positionable laterally adjacent to the at least one engagement member.

9. The connector of claim 7, further comprising a plurality of axially-offset steps extending around at least a portion of the channel, and wherein the selector body includes one or more protrusions abutting and movable with respect to the plurality of steps.

10. The connector of claim 1, further comprising a membrane proximate the second end.

11. The connector of claim 1, wherein the at least one the engagement member includes a depressible surface including a ramp angled with respect to the longitudinal axis.

12. The connector of claim 1, wherein the at least one the engagement member is pivotable about a cantilever joint.

13. A system for transferring fluids, comprising:
a connector, comprising:
a first end, a second end opposite the first end, and a longitudinal axis extending from the first end to the second end;
a piercing member proximate the first end, the piercing member including at least one opening therein;
a lumen extending from the at least one opening of the piercing member to the membrane;
a plurality of engagement members radially spaced about the connector and positioned between the first end and the second end, each of the plurality of engagement members being movable in a direction transverse to the longitudinal axis; and
a selector mechanism rotatably coupled to the connector, the selector mechanism including a selector body defining a sidewall with a plurality of apertures therein, wherein the selector body is rotatable from (i) a first position in which each of the apertures is radially aligned with one of the plurality of engagement members to permit movement of the plurality of engagement members, to (ii) a second position wherein each of the apertures is radially offset with one of the plurality of engagement members such that the sidewall at least partially obstructs movement of the plurality of engagement members.

14. The system of claim 13, wherein the selector mechanism is coaxially mounted on the connector.

15. The system of claim 13, wherein the selector body includes a knob defining a passage therethrough, and wherein at least a portion of the piercing member extends through the passage.

16. The system of claim 13, wherein the connector further comprises a flange longitudinally positioned between the piercing member and the second end, the flange having a width greater than a width of the piercing member, and wherein the selector body extends at least partially through the flange.

17. The system of claim 16, wherein the flange defines a channel extending at least partially therethrough, and a plurality of axially-offset steps at least partially extending around a perimeter of the channel, and wherein the selector body includes one or more protrusions engaging the plurality of steps.

18. The system of claim 13, wherein the selector body includes one or more retention tabs configured to restrict axial movement between the connector and the selector body.

19. The system of claim 13, further comprising an adapter releasably engageable with the connector, the adapter comprising:
a housing defining a first end, a second end, and a longitudinal axis extending from the fist end to the second end;
a cannula positioned within the housing; and
a seal arrangement movably positioned within the housing;
wherein the second end of the connector is positionable within the housing such that the cannula is placed in fluid communication with the lumen.

20. The system of claim 19, wherein the plurality of engagement members of the connector are configured to engage the housing of the adapter to resist axial movement between the connector and the adapter.
